(19) United States
(12) Patent Application Publication
(10) Pub. No.: US 2011/0092725 A1
(43) Pub. Date: Apr. 21, 2011

(54) Catalysis Of Fats And Oils To Alkyl Esters Using Hydrolysis As Pretreatment

(75) Inventor: Ray Jones, Bartlett, TN (US)

(73) Assignee: Lurgi PSI, Inc., Memphis, TN (US)

(21) Appl. No.: 12/581,317

(22) Filed: Oct. 19, 2009

(51) Int. Cl. C11C 3/00

(52) U.S. Cl. 554/163

(57) ABSTRACT

A process that employs hydrolysis of fats and oils as a pretreatment step to prevent or drastically reduce the formation of glycerin decomposition products that occur in systems that use fixed bed or heterogeneous catalysts for simultaneous trans-esterification and esterification of fats and oils to alkyl esters of fatty acids for use as Biofuels, soaps, detergents, solvents or other applications of fatty acid alkyl esters. The pretreatment step is particularly effective for processes using fixed bed catalytic reactors operating at elevated temperatures and pressures sufficient to cause formation of decomposition products of glycerin which is known to be a problem associated with these processes. The pretreatment hydrolysis step allows the formation, separation and recovery of better quality glycerin by-product and minimizing the formation of glycerin decomposition products in the reactors.

### BACKGROUND

The process for making biodiesel or fatty acid methyl esters (FAME), from fats and oils of various sources and qualities, is usually done by either esterification of free fatty acids, and/or subsequent or simultaneous transesterification of the triglyceride content to produce the methyl esters. Traditional processes have used homogeneous liquid catalysts to accomplish either reaction. The use of homogeneous catalysts caused further addition of downstream reagents to “neutralize” and immobilize or deactivate the catalyst still resident in the process streams.

Efforts continue to develop fixed bed heterogeneous catalysts, and admixed heterogeneous catalysts, with recent improvements in capabilities of both catalytic techniques to manufacture fatty acid methyl esters (FAME) also known as “Biodiesel” from both esterification and transesterification reactions.

One fixed bed catalytic reaction technology process is capable of the trans-esterification reaction using fixed bed catalysts on oils with very low free fatty acid content. The process operates at elevated temperatures and pressures and with relatively high excess quantities of methanol present compared to traditional low pressure low temperature trans-esterification. This process has reached commercial scale development and implementation. However, the glycerin produced from the process while very good in glycerin content and appearance, is “off quality” due to the presence of a relatively high concentration of glycerin decomposition and polymerization compounds that are produced by the high temperature and high pressure environment of the process.

One or more new fixed bed catalytic reaction technologies have been developed that are an advancement over the prior technology in that these are capable of simultaneous esterification and trans-esterification reactions to produce fatty acid esters or biodiesel from fats and oils with ostensibly “any” fatty acid content. In this process the esterification reaction proceeds more rapidly than the trans-esterification reaction. Like the previous trans-esterification only process, it operates at elevated temperatures and pressures, with relatively high excess methanol content as the excess reactant. And like the trans-esterification only process, the glycerin produced by the trans-esterification reaction contains substantial amounts of glycerin decomposition or reaction products of glycerin that cause the by-product glycerin to be “off quality” and much more difficult to market as a saleable by-product.

Fat Splitting or hydrolysis of fats and oils has been around for many years. This process uses water plus steam at high pressure and temperature (ie 720 psig and 550 degrees F.) to “split” the triglyceride molecule into its three fatty acid components and liberate the glycerin skeleton molecule. So fats and oils high in triglyceride content are fed to the fat splitter and with more than 98% conversion typical, fatty acids and glycerin are produced. This technology has been around long enough to be considered “open art” although there are relatively few providers of this technology in the Oleochemicals business. The hydrolysis process is useful as a precursor to production of high quality fractionated fatty acid compounds.

This invention is related to the application of fat splitting or hydrolysis of fats and oils, as a precursor step to the fixed bed esterification reaction process in order to resolve the production of the “off spec” glycerin issue while still producing the required quality of FAME under the same reaction conditions. After fat splitting, approximately 2% or less in triglyceride content will remain to be trans-esterified and 98% or more of the feed material as Free Fatty Acid (FFA) will be available for conversion to FAME. The glycerin liberated in the fat splitter or hydrolysis process is drawn off as a weak glycerin stream of 20% to 25% concentration that is upgraded by evaporation to crude glycerin quality and concentration of 80% to 85% glycerin content. This glycerin will meet known industry standards as “crude” glycerin and will be of saleable quality.

The problem of off quality glycerin due to decomposition/reaction products in fixed bed biodiesel reactors operating at temperatures above 300 deg F. came in the form of information regarding glycerin produced from a process developed by Institut Francais du Petrole (IFP) and markets as the Axens “Esterfip” process.

The Axens Esterfip process was first developed as a “Transesterification” only process meaning that high levels of free fatty acid content were not allowed in the reactor. The process was developed apparently under U.S. Pat. No. 6,878,837 in 2005 or similar and later improved under U.S. Pat. No. 7,138,536 in 2006.

The invention here does not work with a trans-esterification only process, but rather works with a process capable of either esterification or especially simultaneous esterification and trans-esterification reactions.

IFP recently was issued a new U.S. Pat. No. 7,420,073 in 2008 for a process that offers staged reactions where feedstocks with up to 40% free fatty acid (ie acid number 20) can be processed first in a fixed bed reactor to convert primarily the free fatty acid via esterification, followed by a second reactor equipped with a different catalyst to trans-esterify the remaining major triglyceride portion.

This invention would not work with the original IFP Axens Esterfip process, it may work with the first reactor type of the latest IFP process for esterification of free fatty acids.

### SUMMARY

The present invention is a process for minimizing the formation of glycerin decomposition products during the trans-esterification reaction in fixed bed or heterogeneous catalyzed reactors during the production of fatty acid alkyl esters, the process comprising using the hydrolysis of a feedstock, comprising fats and oils, as a pretreatment step.

### BRIEF DESCRIPTION OF THE FIGURES

FIG. 1 is a schematic representation of one embodiment of the present invention.

### DESCRIPTION OF PREFERRED EMBODIMENTS

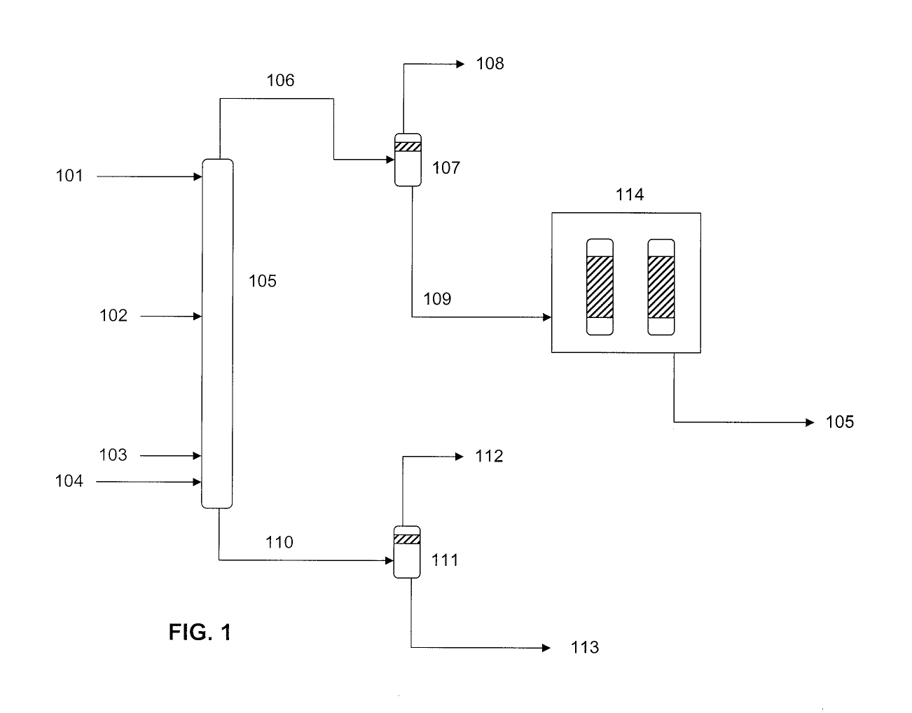

Turning now to FIG. 1, water 101, steam 102, 103, and fats and oils 104 are first fed to a hydrolysis process also known as fat splitting 105, to reduce the triglyceride molecules of the fats and oils to their fatty acid components 106 and liberate the glycerin molecule. The glycerin is removed as weak glycerin water 110 and is upgraded to higher concentration via evaporation 111 to produce good quality “crude” glycerin 113, which can further be easily upgraded to USP quality glycerin, and flash stream 112, which may be sent to an evaporator or vacuum system.

The fatty acids 106 are removed and may be vacuum dried of moisture 107 to become feed 109 to a fixed bed catalytic process 114 (by others) for conversion with methanol to fatty acid methyl esters 105, and flash steam 108, which may be sent to a vacuum system. Said ester mixture is also known as “biodiesel” when used as a motor fuel.

With reference to FIG. 1, the device in this case is a process containing multiple devices, with the principal device being a high pressure hydrolysis (fat splitting) column 105. A variety of downstream devices are possible including almost always a flash vessel 107 for the overhead crude fatty acid to flash off most of the water content, and a flash vessel 111 for the weak glycerin (sweetwater) to remove as much water as will naturally flash from the weak glycerin. One skilled in the art will recognize alternative embodiments, utilizing known equipment downstream of column 105, which may take advantage of the present inventive concept.

Thereafter, devices may include any or all of the following: A glycerin pre-concentrator, a multiple effect evaporator, a fat separator, receiver and pump for condensed water, a vacuum system, a receiver or tank for the weak glycerin water and concentrated recovered glycerin and a receiver or tank for the crude fatty acid.

The present invention is the application of the hydrolysis process (aka fat splitting) to resolve the production of “off quality” glycerin that is normally produced in high temperature, high pressure fixed bed catalytic processes that are capable of converting fats and oils with high free fatty acid content to fatty acid methyl esters or biodiesel.

The use of hydrolysis of fats and oils, also known as “fat splitting” as a pre-processing step for the fixed bed catalytic reaction of fats and oils by the combined trans-esterification and esterification reactions is the invention or IP claimed. The present invention, when applied to those process using fixed bed catalysts to simultaneously produce methyl esters by trans-esterification and esterification reaction with methanol at relative high temperature and pressure, will accomplish the following:
1. Solve the problem of producing “off spec” glycerin containing excessive amounts of glycerin decomposition or reaction products by removing the glycerin from the reaction via the splitting of the triglyceride molecule in the hydrolysis step and removing the glycerin for recovery as good quality glycerin before the fixed bed reaction to FAME occurs.
2. Reduce the size of reactor and quantity of fixed catalyst needed because the esterification reaction would then predominate and the esterification reaction is reported to proceed faster than the trans-esterification reaction.
3. Produce a glycerin by—product of sufficient concentration and quality to allow it to be successfully marketed to glycerin refiners to be upgraded to USP glycerin

When fats or oils are reacted through trans-esterification reactions with methanol, the triglyceride molecule is broken down in reaction steps whereby methanol is affixed to one of the three fatty acid components of the triglyceride molecule forming a fatty acid methyl ester, and leaving a diglyceride molecule.

Subsequent reaction of the di-glyceride molecule likewise removes another fatty acid, form another methyl ester, and leaves a mono-glyceride molecule, which then reacts with another methyl group to form the third methyl ester leaving then the glycerin molecule as free unbound glycerin.

Historically, this was accomplished with a homogeneous methylation catalyst such as sodium or potassium methylate (or methoxide). The reaction conditions for this process are typically very moderate, at or near atmospheric pressure, and at temperatures well below 200 deg F. The reaction is carried out with adequate dosing of catalyst and excess levels of methanol reactant at quantities typically in the 80% to 100% excess methanol above the stoichiometric amount required.

In addition, this process was aided to a high degree of completion by partial reaction followed by separation of the free glycerin, followed then by a second reaction to drive the reaction further to completion because of the reversible nature of the reaction

With the advent of solid fixed bed catalysts, the catalysts were metallic compounds that facilitated the reaction, in one or more beds of catalyst to allow sufficient residence time for the reaction to go to acceptable levels of completion. However, for these fixed bed reactors to be successful, much higher excess of methanol reactant and relatively high temperatures are needed to drive the reaction to completion. Because of the presence of excess methanol at high temperature, the pressure of the reaction must be elevated sufficiently high enough to keep the methanol in liquid state.

As triglycerides react to form methyl esters, glycerin is released from the triglyceride molecule. As the reaction progresses, the glycerin exists as a di-glyceride, and a mono-glyceride before reacting completely to release the glycerin. At the high pressure and temperature residence times of the fixed bed reactions plus the organics already present in various stages of reaction product, the glycerin molecule may decompose or react or react and decompose to form unwanted decomposition compounds that contaminate the glycerin by-product and make it undesirable as a downstream feedstock for upgrading to pharmaceutical (USP) grade glycerin.

In another embodiment of the invention, the application of the fat splitting pretreatment in conjunction with the simultaneous catalyzed esterification and trans-esterification using methanol at temperatures between 150 degrees Centigrade and 280 degrees Centigrade and at pressures from 30 to 70 bar, allows the elimination of one expensive and energy intensive processing step for producing fatty acid methyl esters or biodiesel via esterification reaction.

The process consisting of fat splitting, fatty acid distillation, esterification, and methyl ester distillation, can be reduced to fat splitting, esterification and methyl ester distillation, thereby eliminating the energy intensive and capital cost of the fatty acid distillation step to purify the fatty acid before conventional well known esterification reaction processes.

The use of the overall hydrolysis process step ahead of fixed bed catalyzed esterification and transesterification is the invention claim.

### Processes

The processes of this invention are as follows:
1. Hydrolysis (or fat splitting) of fats and oils containing mixtures of free fatty acids (FFA) and triglycerides (TG) to substantially convert the triglyceride content to free fatty acids.
2. Flash evaporation of water content from the free fatty acids exiting the hydrolysis unit.
3. Flash evaporation of as much water as will naturally flash from the reduced pressure of the weak glycerin stream also known as “sweetwater”.
4. Optional Preconcentration of the weak glycerin stream to 20% to 25% glycerin concentration
5. Multiple effect vacuum evaporation of the weak or preconcentrated glycerin to a marketable crude glycerin concentration of 80% to 85% glycerin content.

The invention encompasses the utilization of the processes described above to produce a crude fatty acid material that is suitable for feed to a fixed bed catalytic process capable of esterification of fatty acids and simultaneous transesterification of residual triglycerides. Such processes have been developed by others, but do not include the upstream modification to hydrolyze the fat and recover the glycerin. The existing or known fixed bed catalytic processes operate without this pretreatment step, and thus are subject to produce glycerin of high concentration but with undesirable quality due to high content of glycerin polymerization or decomposition products.

By reducing the formation of glycerin inside the alkyl ester reactors, the pretreatment step minimizes the production of “off-spec” glycerin due to decomposition products. The relatively small amount of glycerin that does form in the alkyl ester reactors under simultaneous trans-esterification of triglycerides along with the more prevalent esterification of fatty acids, can be physically separated and recombined with the higher quality glycerin or alternately separated and sold as lower quality, burned or disposed as waste material.

The final result is the production of the required fatty acid alkyl esters including the methyl ester form of these materials produced from the reaction of methanol with fatty acids or triglycerides in the presence of heterogeneous catalysts at elevated temperatures and pressures, and the production of much better quality crude glycerin that can be upgraded to technical grade or USP grade glycerin by subsequent processing.

By removing the glycerin up front in the hydrolysis step, although at weaker concentration, the quality of the glycerin is preserved and is upgraded by conventional evaporation to a well known crude glycerin material that is acceptable as feedstock for upgrading to technical or pharmaceutical grade glycerin.

Since the efficiency of the hydrolysis process is at least 98%, then only 2% or less of the triglyceride content entering the hydrolysis step will remain going into the fixed bed catalytic reactors.

Since glycerin produced from the trans-esterification of triglycerides usually approaches 10% of the triglyceride amount by weight, then a factor of 10% of 2% or an equivalent of 0.2% glycerin will remain in the methyl ester produced by the fixed bed reaction system.

Decomposition products of the glycerin can equal up to 30% to 40% by weight of the glycerin produced. Therefore the decomposition products produced in the reactor system would equal 0.6% to 0.8% of the total glycerin produced by the system when added back to the glycerin recovered as crude glycerin.

Thus in this way the amount of glycerin decomposition products can be significantly reduced from 30% to 40% of glycerin produced to approximately 0.8% of glycerin produced.

The expected reduction is that decomposition products will be reduced by 97% to 98% through the application of hydrolysis ahead of the fixed bed catalytic reaction system.

The inventive process is capable of simultaneous esterification and trans-esterification reactions in the same fixed catalyst bed reactor, normally consisting of two fixed bed reactors in series in order to provide adequate residence time for the reaction to go as near to completion as possible.

The present invention is based on the recognition that glycerin is only produced from the trans-esterification reaction and not from the esterification reaction. Whereby, hydrolysis or fat splitting substantially removes the glycerin as a pretreatment step, and leaving 2% or less triglycerides as residual, becomes an excellent feedstock to a reactor which will convert the free fatty acid to methyl esters (biodiesel) and still convert the residual 2% triglyceride also to biodiesel, while making very little of the glycerin in the fixed bed reactor, and thereby minimizing any glycerin decomposition products.

The present invention may have application on any process that is able to substantially esterify free fatty acids into methyl ester or biodiesel product with capability to also convert smaller amounts of trigycerides to methyl ester or biodiesel product also.

### EXAMPLES

It has been reported that glycerin decomposition products from catalyzed reaction to produce alkyl esters (biodiesel) from methanol and triglycerides can be as high as 30% by weight of the glycerin produced as the by-product.

The addition of fat splitting or hydrolysis will convert the triglyceride content to fatty acids and free glycerin in a process that utilizes water and steam to split the fat into glycerin and fatty acid.

The efficiency of conversion of triglycerides by hydrolysis is typically at least 98%.

### Example 1

Basis: 1000 lbs of triglyceride feed (871 g/mole average molecular weight)

Converted in the catalyzed reactor at 180 to 230 deg. C. and 40 to 60 Bar would produce Typically 100 lbs of glycerin products. (approx. 10% of the Triglyceride)

But at 30% decomposition the glycerin produced is only 70 lbs of Glycerin and 30 lbs of Decomposition products

By processing with hydrolysis first the feed material converts to 880.2 lbs fatty acid, 99.8 lbs Glycerine, and 20 lbs tri-glyceride (2%).

Then the 20 lbs Triglyceride converts via the trans-esterification reaction to 19.8 react to form methyl ester and 0.2 lbs glycerin co-products.

At 30% decomposition rate the 0.2 lbs glycerin becomes 0.14 lbs glycerin and 0.06 lbs decomposition products.

Total clean glycerin produced its 99.8+0.14=99.94 lbs glycerin+0.06 lbs decomposition products.

Thus the reduction of glycerin decomposition products went from approximately 30 lbs to 0.06 lbs.

The reduction in decomposition is 98% comparable to the degree of fat splitting.

The improved recovery of glycerin product is 99.9 lbs vs 70 lbs or 42% better glycerin recovery.

### Example 2

A process that allows wide feedstock flexibility to produce biodiesel out of normal and lower quality feedstocks consists of four processing steps.
1. Hydrolysis of the feed (fat splitting)
2. Fatty acid distillation (to purify the fatty acid for esterification)
3. Esterification to produce alkyl esters (methyl ester from methanol and fatty acid)
4. Ester distillation to purify the final product

Using a combination of hydrolysis and the catalyzed process capable of simultaneous esterification and trans-esterification (but primarily esterification), the process reduces to a three step process.
1. Hydrolysis of the feed (fat splitting)
2. Esterification/Trans-esterification (180 to 230 deg C., 40 to 60 Bar)
3. Ester distillation to purify the final product

The process that was eliminated used an energy consumption of approximately
0.110 mM Btu per metric ton of feed And
210 kWh per metric ton of feed in electric power

This amounts to a combined total equivalent of 0.8276 Million Btu per metric ton of feed in lower energy consumption.

What is claimed is:

1: A process for minimizing the formation of glycerin decomposition products during the trans-esterification reaction in fixed bed or heterogeneous catalyzed reactors during the production of fatty acid alkyl esters, said process comprising using the hydrolysis of a feedstock, comprising fats and oils, as a pretreatment step.

2: The process of claim 1 wherein said hydrolysis is carried out by conventional hydrolyzing or “fat splitting” using water and steam to produce mixtures of fatty acids, wherein said feedstock is selected from the group consisting of animal fats, vegetable oils, algae oils, acid oils, recycle cooking oils, and mixtures or combinations thereof.

3: The process of claim 1 wherein said catalyzed reaction comprises a process capable of simultaneous esterification and trans-esterification reactions to produce fatty acid alkyl esters.

4: The process of claim 3, wherein said fatty acid alkyl esters are further refined to be used as biofuel, detergents or solvents.

5: The process of claim 3 wherein said catalyzed reaction process uses fixed bed heterogeneous catalyst.

6: The process of claim 1, wherein said trans-esterification reaction occurs between mixtures of fatty acids and triglycerides with short chain alcohols.

7: The process of claim 5 wherein said short chain alcohols are either methanol or ethanol.

8: The process of claim 1 wherein the glycerin decomposition products occur as a result of the elevated reaction temperatures and pressures necessary to maintain the volatile alcohol in its liquid state, and for the reactions of fatty acids and triglycerides to proceed on a heterogeneous catalyst at sufficient rate for commercial production of alkyl esters.

9: The process of claim 1 wherein said trans-esterification reaction takes place at a temperature between about 180 degrees Centigrade and about 230 degrees Centigrade.

10: The process of claim 1 wherein said trans-esterification reaction takes place at a pressure between about 40 bar and about 60 bar.

11: The process of claim 1 wherein the formation of glycerin decomposition products is reduced as a result of the reduction of triglyceride content in the feedstocks relative to the fatty acid content in the feedstock prior to the esterification and trans-esterification reactions.
